(19) United States
(12) Patent Application Publication
(10) Pub. No.: US 2002/0128918 A1
(43) Pub. Date: Sep. 12, 2002

(54) System, method and storage medium for back ordering out of stock products

(75) Inventors: Li-Lung Chao, Bedford, NY (US); Thomas R. James, Danbury, CT (US)

Correspondence Address: Philmore H. Colburn II, Cantor Colburn LLP, 55 Griffin Road South, Bloomfield, CT, 06002, US

(73) Assignee: International Business Machines Corporation, Armonk, NY (US)

(21) Appl. No.: 09/800,690

(22) Filed: Mar. 7, 2001

(51) Int. Cl. G06F 17/60

(52) U.S. Cl. 705/26; 705/28

(57) ABSTRACT

An exemplary embodiment is a system, method and storage medium for back ordering out of stock products. The system includes a host system for receiving an order for a product from a user, determining whether inventory for said product satisfies said order, notifying said user if said inventory for said product does not satisfy said order, receiving a back order request from said user to back order said product if said inventory for said product does not satisfy said order, determining an amount of said product for meeting said back order request, acquiring said amount and updating said inventory, notifying said user that said back order request has been satisfied and receiving a delivery request from said user to deliver said product. A network is coupled to the host system, and a database is coupled to the host system for storing data relating to the back ordering out of stock products.

### BACKGROUND

The invention relates generally to an electronic catalog inventory system and, more specifically, to a system, method and storage medium for back ordering out of stock products.

Catalog procurement systems have traditionally been manual, labor intensive and costly operations. Suppliers, for example, would mass mail catalogs to potential customers, the customers would browse the catalogs and select items to be purchased and then the customer would complete a paper order form, or call the supplier to order the items. The entire process, from preparing the catalog to receipt of the order, was labor intensive and time consuming. Commonly, the product inventory data was updated manually. Thus, the potential for human was ripe. Such human error would cause logistical nightmares and compromise inventory system efficiency. Further, manual inventory systems were slow to determine whether a product was out of stock, and whether it should be back ordered.

Therefore, electronic catalogs (e.g., catalogs provided via the Internet) have become popular. Fewer mistakes are made, orders are processed quicker and more efficiently. Also, electronic orders are usually delivered faster than orders taken from paper catalogs. Although an electronic catalog system may be able to determine whether a particular product is out of stock, often, the data is erroneous, out dated and not a true indication of a supplier's inventory. Further, knowing whether the customer wishes the item to be back ordered is not determined.

Thus, there is a need for an efficient, inexpensive and effective system, method and storage medium for back ordering out of stock products.

### SUMMARY

An exemplary embodiment is a system, method and storage medium for back ordering out of stock products. The system includes a host system for receiving an order for a product from a user, determining whether inventory for said product satisfies said order, notifying said user if said inventory for said product does not satisfy said order, receiving a back order request from said user to back order said product if said inventory for said product does not satisfy said order, determining an amount of said product for meeting said back order request, acquiring said amount and updating said inventory, notifying said user that said back order request has been satisfied and receiving a delivery request from said user to deliver said product. A network is coupled to the host system, and a database is coupled to the host system for storing data relating to the back ordering out of stock products.

### BRIEF DESCRIPTION OF THE DRAWINGS

Referring now to the drawings wherein like elements are numbered alike in several figures:

FIG. 1 is a block diagram of a system for back ordering out of stock products in one embodiment of the invention; and

FIG. 2 illustrates an exemplary method for back ordering out of stock products in one embodiment of the invention.

### DETAILED DESCRIPTION

As discussed, determining whether a particular product is out of stock and whether the customer wishes the item to be back ordered is needed. One embodiment for an electronic catalog system includes an electronic marketplace (“e-Marketplace”) that hosts a Web site for multiple suppliers selling various products. Supplier catalogs, along with available quantities of the products may be included. Thus, when a customer submits an order, the e-Marketplace Web site may provide real-time inquiries on whether the quantities of products ordered are in stock, and can be fulfilled. In electronic catalog systems of the past, if the product was out of stock, the customer could not even create an order. This problem resulted from the inability to link from the electronic catalog to the suppliers' inventory database (in addition to inaccurate and infrequent updates to the inventory database). Further, as previously discussed, an “out of stock” status was not always a true indication of the supplier's inventory. Thus, the customer's business was unnecessarily lost, and his return business was unlikely. However, the embodiments discussed herein resolve these problems with an efficient, inexpensive and effective system, method and storage medium for back ordering out of stock products.

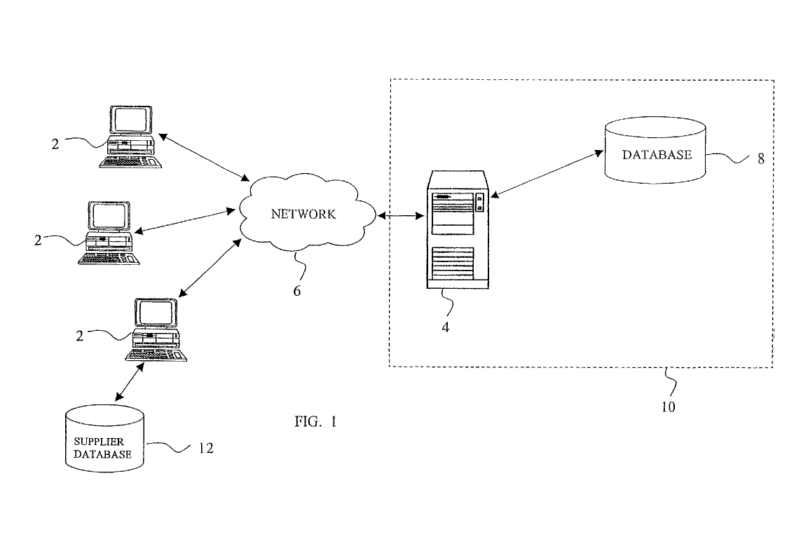

FIG. 1 is a block diagram of a system for back ordering out of stock products in one embodiment of the invention. The system may include one or more user systems 2 coupled to a host system 10 via a network 6. Each user system 2 may be implemented using a general-purpose computer executing a computer program for carrying out the processes described herein. The network 6 may be any type of known network including a local area network (LAN), wide area network (WAN), global network (e.g., Internet), intranet, extranet, etc. The user systems 2 may be coupled to the host system 10 through multiple networks (e.g., intranet and Internet) so that not all user systems 2 are coupled to the host system 10 via the same network. One or all of the user systems 2 and the host system 10 may be connected to the network 6 in a wireless fashion and network 6 may be a wireless network. In a preferred embodiment, the network 6 is the Internet and user system 2 executes a user interface application (e.g., Web browser) to contact the host system 10 through the network 6. Alternatively, a user system 2 may be implemented using a device programmed primarily for accessing network 6 such as WebTV or a network computer. Note that one or more user systems 2 may be operated by one or more customers. Additionally, one or more user systems 2 may be operated by one or more suppliers. A user system 2 operated by a supplier may include a supplier database 12 for maintaining supplier inventory data.

The host system 10 includes a processor, such as a server 4 operating in response to a computer program stored in a storage medium accessible by the server. The server 4 may operate as a network server (often referred to as a Web server) to communicate with the user systems 2. The server 4 handles sending and receiving information to and from user systems 2 and can perform associated tasks. The server 4 may also include a firewall to prevent unauthorized access to the host system 10 and enforce any limitations on authorized access. The firewall may be implemented using conventional hardware and/or software as is known in the art. The server 4 may also operate as an applications server. In other words, the server 4 may execute one or more computer programs to interact with a database 8. It is understood that separate servers may be used to implement the network server functions and the applications server functions. Alternatively, the network server, firewall and the applications server may be implemented by a single server executing computer programs to perform the requisite functions.

The database 8 contains a variety of information related to inventory of a product. In one embodiment, the database 8 includes information concerning product tracking, back orders, out of stock products and the like. Server 4 may interact with the database 8 through existing legacy components. Changes to the database 8 can be made dynamically, in real time to instantaneously update information contained in the database 8. Thus, updates to the inventory may be processed immediately by server 4 without human intervention. Note that in other embodiments, the database 8 may be one or more databases, including databases remotely located from the host system 10. For example, the database 8 may include a server database and an inventory database. The inventory database may be further divided into a product catalog database and a customer order database. The product catalog database may contain the inventory data for each product offered in a catalog. The customer order database may contain the customer order data, such as customer identity, product identity, product quantity and order date.

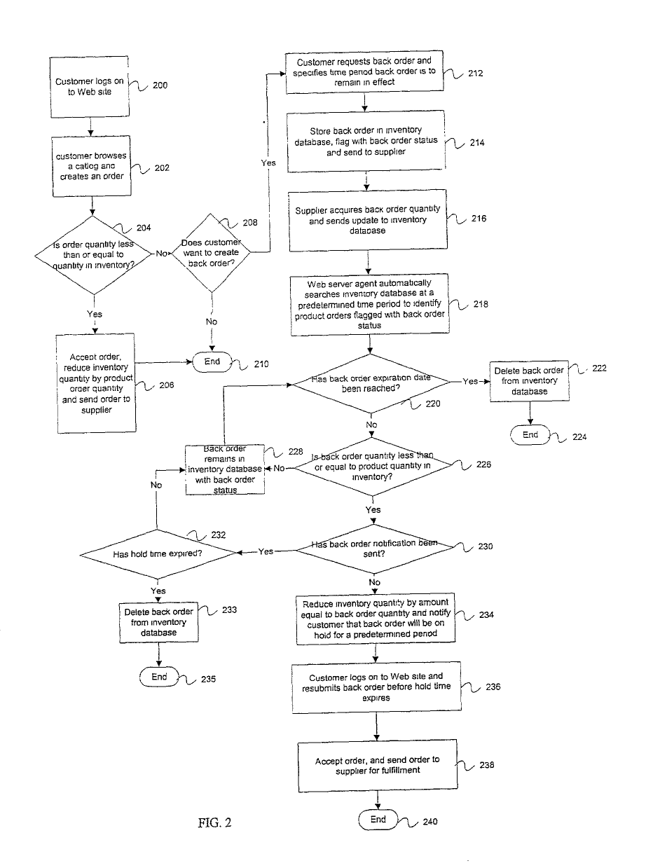

Referring to FIG. 2, operation of the system will now be described. As discussed, the user system 2 may include a user interface application (e.g., a Web browser), which allows the user system 2 to contact the host system 10 via network 6 (e.g., the Internet). In one embodiment, a remote user system 2 may be used by a customer to contact an online product catalog provided via the host system 10. Additionally, as previously mentioned, another user system 2 may be used by a supplier. First, in step 200, a customer logs on to a Web site containing the product catalog. In step 202, after the customer has selected a product from the catalog, the customer creates an order. The order may contain one or more products, along with the requested quantity. The order may be created using electronic techniques commonly known, such as filling out and submitting an electronic order form. Step 204 determines whether the quantity ordered by the customer is less than or equal to the quantity in inventory. In other words, in step 204, the inventory data in the database 8 is compared to the customer's order. If the inventory is sufficient for the customer's order, in step 206, the customer's order is accepted, the inventory data is reduced by the quantity in the customer's order, the order is sent to a supplier for fulfillment and the process ends in step 210.

If, in step 204, the quantity ordered by the customer is greater than the quantity in inventory, the customer is queried about creating a back order request for the product. If the customer decides not to create a back order request, the process ends in step 210. Otherwise, in step 212, the customer requests a back order and is queried on specifying a time period for keeping the back order request active. Thus, in step 212, the customer may enter a time period on an electronic form or select from a predetermined list of time periods. In step 214, the customer's back order request is stored in the database 8, flagged with a back order status indicator and sent to a supplier for fulfillment. In step 216, the supplier acquires the back order quantity and updates the inventory data in the database 8. In step 218, the inventory data in the database 8 is automatically searched at a predetermined time period to identify product orders flagged with a back order status. Note that a web server agent program, or the like, may be used to perform the search function.

Next, step 220 determines whether the back order expiration date has been reached. Note that the back order expiration date was previously defined in step 212. Again, a web server agent program, or the like may be used in any of the steps. If the back order expiration date has been reached, the back order is deleted from the database 8 in step 222, and the process ends in step 224. If the back order time period has not expired, step 226 determines whether the back order quantity is less than or equal to the quantity in inventory. Note that step 226 is used to check whether changes to the inventory occurred during the time period set for the back order to expire, and if so, to take action to update the inventory accordingly. If the back order quantity is greater than the quantity in inventory, then in step 228, the back order remains in the database 8, and step 220 is repeated. Otherwise, step 230 determines whether a back order notification has been sent to the customer. The back order notification informs the customer that the back order has been filled and will be “on hold” for a predetermined period. Note that the hold period is not the same as the time period discussed in step 212 (the time period in step 212 is determined by the customer).

If a back order notification has been sent to the customer, step 232 determines whether the hold time has expired. If the hold time has expired, in step 233, the back order is deleted from the database 8, and the process ends in step 235. If the hold time has not expired, step 228 is repeated. If step 230 determines that a back order notification was not sent to the customer, then in step 234, the inventory quantity is reduced by an amount equal to the back order quantity, and the customer is notified that the back order is available and will be held for a predetermined period. Next, in step 236, the customer logs on to the web site and resubmits or confirms the back order request before the hold time expires. In step 236, the customer's request is accepted and sent to the supplier for fulfillment, and the process ends in step 240.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A system for back ordering out of stock products, the system comprising:
a host system for receiving an order for a product from a user, determining whether inventory for said product satisfies said order, notifying said user if said inventory for said product does not satisfy said order, receiving a back order request from said user to back order said product if said inventory for said product does not satisfy said order, determining an amount of said product for meeting said back order request, acquiring said amount and updating said inventory, notifying said user that said back order request has been satisfied and receiving a delivery request from said user to deliver said product;
a network coupled to said host system; and
a database coupled to said host system for storing data relating to said back ordering out of stock products.

2. The system of claim 1, further including:
a user system coupled to said network; and
said user system accessing said host system via said network.

3. The system of claim 1, wherein said acquiring said amount and updating said inventory includes said host system:
requesting said amount form a supplier; and
receiving a request from said supplier to add said amount to said inventory.

4. The system of claim 1, further including said host system:
receiving a time period request from said user for setting a time that said back order request is to remain in effect;
determining whether said time period request has expired; and
deleting said back order request if said time period request has expired.

5. The system of claim 1, further including said host system:
notifying said user that said back order request will remain on hold for a predetermined time;
determining whether said predetermined time has expired; and
deleting said back order request if said predetermined time has expired.

6. The system of claim 1, wherein said delivery request includes said host system:
sending a back order confirmation request to said user;
receiving a back order confirmation; and
reducing said inventory data to reflect said back order confirmation.

7. A system for back ordering out of stock products, the system comprising:
a host system for receiving an order for a product from a user, determining whether inventory for said product satisfies said order, notifying said user if said inventory for said product does not satisfy said order, receiving a back order request from said user to back order said product if said inventory for said product does not satisfy said order, sending a supplier request to a supplier for fulfilling said back order request, receiving an inventory update request from said supplier, wherein said inventory update request includes an amount of said product for fulfilling said back order request, notifying said user that said back order request has been satisfied and receiving a delivery request from said user to deliver said product;
a network coupled to said host system; and
a database coupled to said host system for storing data relating to said back ordering out of stock products.

8. The system of claim 7, further including said host system:
receiving a time period request from said user for setting a time that said back order request is to remain in effect;
determining whether said time period request has expired; and
deleting said back order request if said time period request has expired.

9. The system of claim 7, further including said host system:
notifying said user that said back order request will remain on hold for a predetermined time;
determining whether said predetermined time has expired; and
deleting said back order request if said predetermined time has expired.

10. The system of claim 7 wherein said delivery request includes said host system:
sending a back order confirmation request to said user;
receiving a back order confirmation; and
reducing said inventory data to reflect said back order confirmation.

11. A method for back ordering out of stock products, the method comprising:
receiving an order for a product from a user;
determining whether inventory for said product satisfies said order;
notifying said user if said inventory for said product does not satisfy said order;
receiving a back order request from said user to back order said product if said inventory for said product does not satisfy said order;
determining an amount of said product for meeting said back order request;
acquiring said amount and updating said inventory;
notifying said user that said back order request has been satisfied; and
receiving a delivery request from said user to deliver said product.

12. The method of claim 11, wherein said acquiring said amount and updating said inventory includes:
requesting said amount form a supplier; and
receiving a request from said supplier to add said amount to said inventory.

13. The method of claim 11, further including:
receiving a time period request from said user for setting a time that said back order request is to remain in effect;
determining whether said time period request has expired; and
deleting said back order request if said time period request has expired.

14. The method of claim 11, further including:
notifying said user that said back order request will remain on hold for a predetermined time;
determining whether said predetermined time has expired; and
deleting said back order request if said predetermined time has expired.

15. The method of claim 11, wherein said delivery request includes:
sending a back order confirmation request to said user;
receiving a back order confirmation; and
reducing said inventory data to reflect said back order confirmation.

16. A method for back ordering out of stock products, the method comprising:
receiving an order for a product from a user;
determining whether inventory for said product satisfies said order;
notifying said user if said inventory for said product does not satisfy said order;
receiving a back order request from said user to back order said product if said inventory for said product does not satisfy said order;
sending a supplier request to a supplier for fulfilling said back order request;
receiving an inventory update request from said supplier, wherein said inventory update request includes an amount of said product for fulfilling said back order request;
notifying said user that said back order request has been satisfied; and
receiving a delivery request from said user to deliver said product.

17. The method of claim 16, further including:
receiving a time period request from said user for setting a time that said back order request is to remain in effect;
determining whether said time period request has expired; and
deleting said back order request if said time period request has expired.

18. The method of claim 16, further including:
notifying said user that said back order request will remain on hold for a predetermined time;
determining whether said predetermined time has expired; and
deleting said back order request if said predetermined time has expired.

19. The method of claim 16, wherein said delivery request includes:
sending a back order confirmation request to said user;
receiving a back order confirmation; and
reducing said inventory data to reflect said back order confirmation.

20. A storage medium encoded with machine-readable computer program code for back ordering out of stock products, the storage medium including instructions for causing a processor to implement a method comprising:
receiving an order for a product from a user;
determining whether inventory for said product satisfies said order;
notifying said user if said inventory for said product does not satisfy said order;
receiving a back order request from said user to back order said product if said inventory for said product does not satisfy said order;
determining an amount of said product for meeting said back order request;
acquiring said amount and updating said inventory;
notifying said user that said back order request has been satisfied; and
receiving a delivery request from said user to deliver said product.

21. A storage medium encoded with machine-readable computer program code for back ordering out of stock products, the storage medium including instructions for causing a processor to implement a method comprising:
receiving an order for a product from a user;
determining whether inventory for said product satisfies said order;
notifying said user if said inventory for said product does not satisfy said order;
receiving a back order request from said user to back order said product if said inventory for said product does not satisfy said order;
sending a supplier request to a supplier for fulfilling said back order request;
receiving an inventory update request from said supplier, wherein said inventory update request includes an amount of said product for fulfilling said back order request;
notifying said user that said back order request has been satisfied; and
receiving a delivery request from said user to deliver said product.
